(19) United States
(12) Patent Application Publication
(10) Pub. No.: US 2026/0157452 A1
(43) Pub. Date: Jun. 11, 2026

(54) Floating Swimwear

(71) Applicant: Rojan John Pappady, New Hyde Park, NY (US)

(72) Inventor: Rojan John Pappady, New Hyde Park, NY (US)

(21) Appl. No.: 19/538,699

(22) Filed: Feb. 12, 2026

Related U.S. Application Data
(63) Continuation-in-part of application No. 18/179,148, filed on Mar. 6, 2023.
(60) Provisional application No. 63/317,153, filed on Mar. 7, 2022.

(51) Int. Cl. A41D 7/00; A41D 31/02; B32B 3/16; B32B 27/08; B32B 27/28; B32B 27/32

(52) U.S. Cl. CPC A41D 7/001; A41D 31/02; B32B 3/16; B32B 27/08; B32B 27/285; B32B 27/32; A41D 2300/322; A41D 2500/52; B32B 2250/03; B32B 2250/24; B32B 2250/40; B32B 2437/00

(57) ABSTRACT

A swimwear composed of a buoyant material. The swimwear, covering a portion of the torso and a portion of the legs or a user, allows for a uniform distribution of buoyancy. A collar made from said buoyant material positioned circumferentially around the neck of the user enhances head support. Furthermore, the construction of the buoyant material, comprising hexagonal low density polyethylene sheets composed of spandex layers and low-density polyethylene, provides buoyancy without limiting the mobility of the user. Stretchable spacing between the hexagonal low-density polyethylene sheets provides users with elasticity in many directions, however since the full buoyant material still has limited stretchability, a plurality of flexible joints aligned with the sides and joints of the user allow for improved mobility. And an internal harness stabilizes the floating swimwear on the user.

### FIELD OF THE INVENTION

The present invention relates generally to an apparatus for safety swim wear. More specifically, the present invention is an apparatus for safety swim wear which will provide a means for safe flotation while not impeding or limiting the mobility and bodily function of the user.

### BACKGROUND OF THE INVENTION

Currently available flotation solutions include life jackets, personal flotation devices (PFDs), inflatable swim aids, foam-based vests, kickboards, arm floaties, and buoyancy belts. These devices are commonly used by children, novice swimmers, individuals undergoing aquatic therapy, and recreational swimmers seeking additional safety in the water. While such devices provide buoyancy, they are often designed primarily for passive flotation or emergency use, rather than for active swimming with natural body movement.

Traditional life jackets and vests rely on bulky foam panels or inflatable chambers positioned around the torso. Although effective at keeping a user afloat, these designs often create unnatural buoyancy distribution, forcing the user into an upright or tilted position that does not resemble natural swimming posture. As a result, such devices may hinder swimming technique, increase drag, and limit arm, shoulder, and leg movement. In addition, bulky flotation devices can be uncomfortable, particularly during extended wear, and may ride up the body due to uneven buoyant forces.

Inflatable flotation devices, while less bulky when deflated, present additional drawbacks. These devices typically require manual or automatic inflation, introducing the risk of failure due to puncture, valve malfunction, or improper inflation. Furthermore, inflatable components may not provide consistent buoyancy distribution and can shift during movement, reducing stability and comfort.

Foam-based swim aids such as kickboards, belts, and arm floaties provide localized buoyancy but do not integrate seamlessly with the body. These devices often restrict natural movement, are limited to specific swimming exercises, and may encourage improper swimming posture. Arm floaties and similar accessories can impede arm rotation and shoulder engagement, while belts and boards may fail to provide adequate support for the upper body or head.

Accordingly, there exists a need in the art for a buoyant swimwear garment that integrates flotation directly into wearable swimwear, distributes buoyancy in a balanced and natural manner, accommodates a wide range of body sizes, and allows for unrestricted swimming movement, while also providing comfort, stability, and safety.

An objective of the present invention is to provide a floating swimwear garment that overcomes the limitations of existing flotation devices by combining distributed buoyancy, flexibility, comfort, and natural movement into a single wearable article.

The present invention achieves this objective by providing a floating swimwear composed substantially of a buoyant material that integrates flotation directly into the structure of the garment. Rather than relying on bulky foam blocks or inflatable chambers, the buoyant material comprises a low-density material combined with an elastic material, allowing the swimwear to conform to the user's body while still providing sufficient lift in the water.

In particular, the low-density material is formed from hexagonal low-density polyethylene sheets arranged in a modular configuration. This structure allows buoyancy to be evenly distributed across the front and rear portions of the garment, creating a floating experience that closely resembles the user's natural buoyancy profile. Unlike conventional flotation devices that force the body into unnatural positions, the present invention supports the user in a horizontal, swim-ready orientation.

The inclusion of elastic layers and stretchable spacing between the hexagonal sheets enables the garment to flex and move with the wearer. This design significantly reduces resistance during swimming motions and prevents the stiffness commonly associated with foam flotation garments. Additionally, the elastic materials allow the swimwear to accommodate different body shapes and sizes, making the invention suitable for both adults and children.

Another objective of the present invention is to provide enhanced mobility at key anatomical joints. To accomplish this, the swimwear incorporates a plurality of flexible joints positioned at the shoulders, sides of the torso, and legs. These flexible joints are free of the low-density material and instead utilize elastic material, thereby aligning with the wearer's natural joint locations. This configuration minimizes restriction during arm rotation, torso twisting, and leg movement, allowing the user to swim, tread water, or move freely without impediment.

The present invention further addresses stability and comfort through optional features such as a collar positioned around the neck, which provides additional buoyancy near the head to assist in keeping the user's face above water. A harness system, positioned within the swimwear, secures the garment to the wearer's body and prevents the swimwear from shifting or riding upward during use. This internal harness improves fit, comfort, and overall safety, particularly during active swimming.

In some embodiments, the floating swimwear may be configured as multiple interconnected portions, such as a top portion, middle portion, and bottom portion, secured via zipper or buckle assemblies. This modular design allows for easier donning and removal, improved fit customization, and adaptability to different user needs.

Overall, the present invention provides a wearable flotation solution that blends seamlessly with swimwear aesthetics while delivering reliable buoyancy, enhanced mobility, and improved user comfort. By addressing the shortcomings of traditional flotation devices, the invention offers a more natural and more enjoyable floating and swimming experience for users of varying ages and skill levels.

### BRIEF DESCRIPTION OF THE DRAWINGS

FIG. 1 is a front view of one embodiment of the present invention, with dotted lines to represent the harness and buckle assembly inside of the present invention.

FIG. 2 is a front view of the top portion of one embodiment of the present invention, with dotted lines to represent the harness and buckle assembly inside of the present invention.

FIG. 3 is a right side view of the top portion of one embodiment of the present invention.

FIG. 4 is a front left view of the bottom portion of one embodiment of the present invention.

FIG. 5 is a front view of one embodiment of the present invention.

FIG. 6 is a rear view of one embodiment of the present invention.

FIG. 7 is a diagram of a first zipper assembly of one embodiment of the present invention.

FIG. 8 is a diagram of a rear zipper assembly of one embodiment of the present invention.

FIG. 9 is a front view of one embodiment of the present invention.

FIG. 10 is a sectional view of a buoyant material of the present invention.

FIG. 11 is a detailed view of a buckle assembly of an alternative embodiment of the present invention, with dotted lines to represent the buckle assembly inside of the present invention.

FIG. 12 is a front view of one embodiment of the present invention.

FIG. 13 is a rear view of one embodiment of the present invention.

FIG. 14 is a front detailed view of a middle portion of one embodiment of the present invention.

FIG. 15 is a diagram or a middle zipper assembly of an embodiment of the present invention.

FIG. 16 is a front view of a user wearing one embodiment of the present invention.

FIG. 17 is profile view of a user wearing one embodiment of the present invention while remaining buoyant in a horizontal face-up position.

FIG. 18 is profile view of a user wearing one embodiment of the present invention while remaining buoyant in a vertical position.

FIG. 19 is profile view of a user wearing one embodiment of the present invention while remaining buoyant in a horizontal back-up position.

FIG. 20 is a perspective view of the bottom portion of one embodiment of the present invention.

FIG. 21 is a perspective view of the top portion of one embodiment of the present invention.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “top”, “bottom”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly” and “radially” generally refer to the orientation of a surface relative to its axis of elongation, or axis of rotation, as appropriate.

The present disclosure includes many aspects and features. Moreover, while many aspects and features relate to, and are described in the context of a keychain tag protector, embodiments of the present disclosure are not limited to use only in this context.

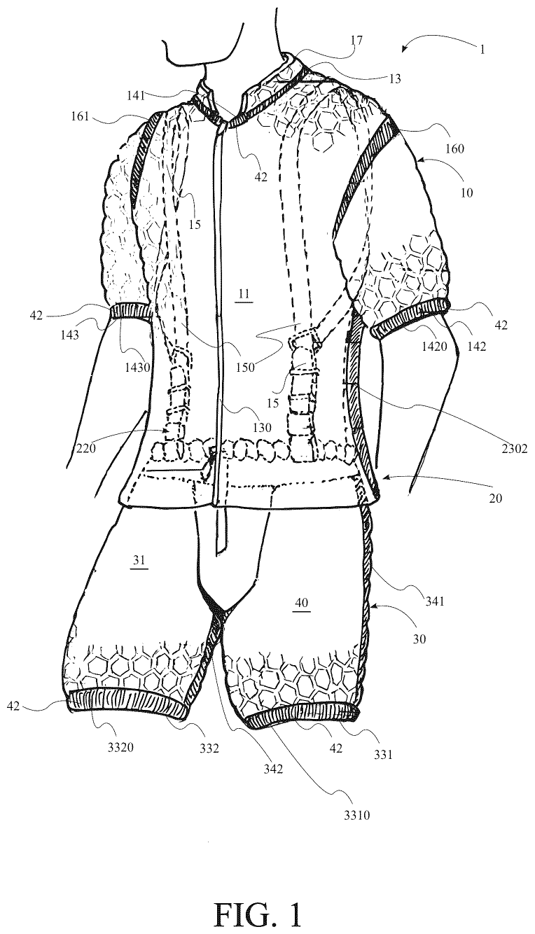

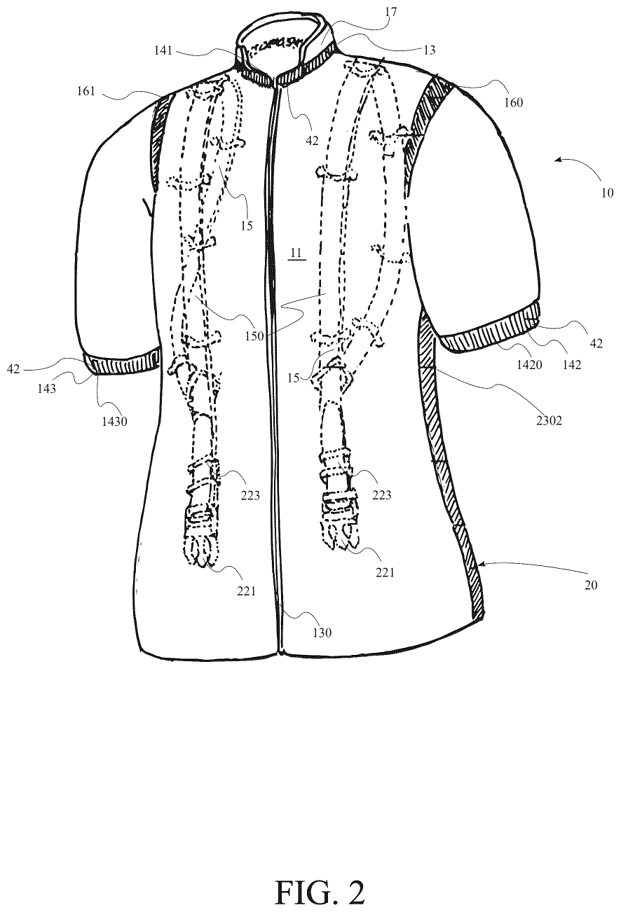

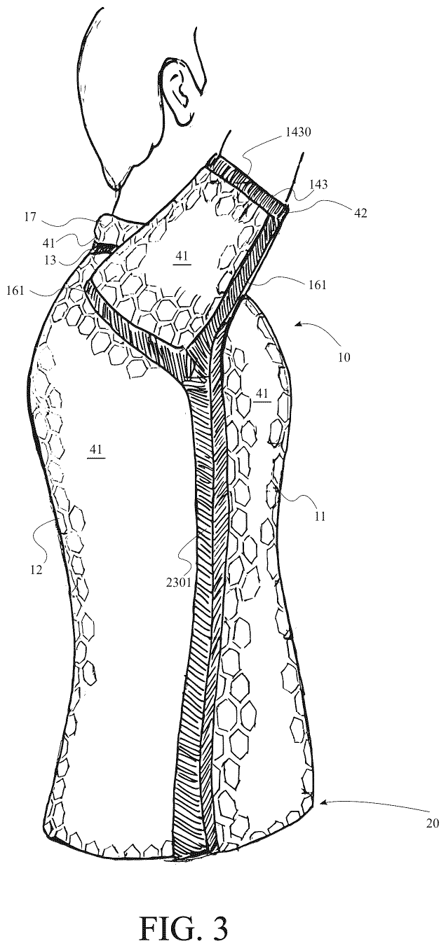

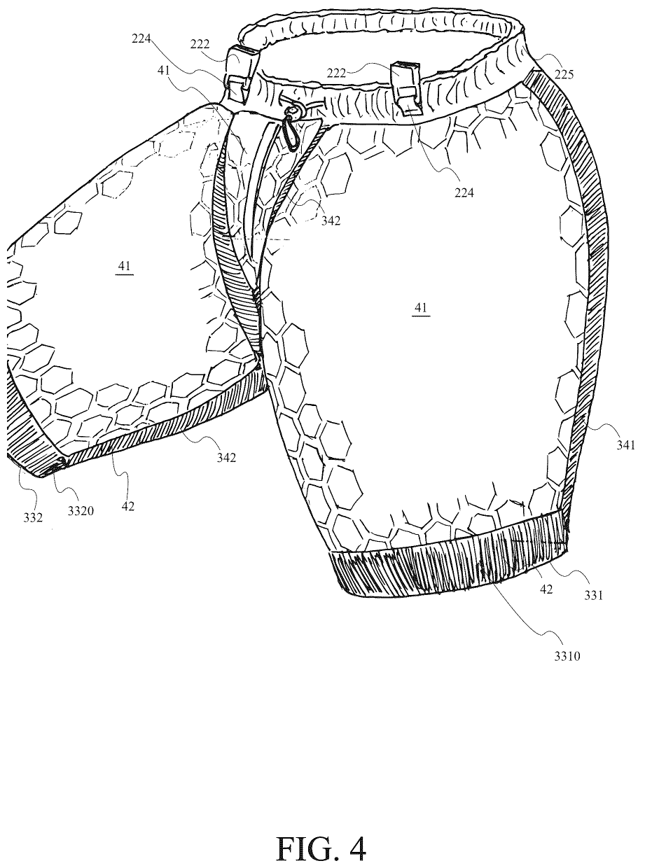

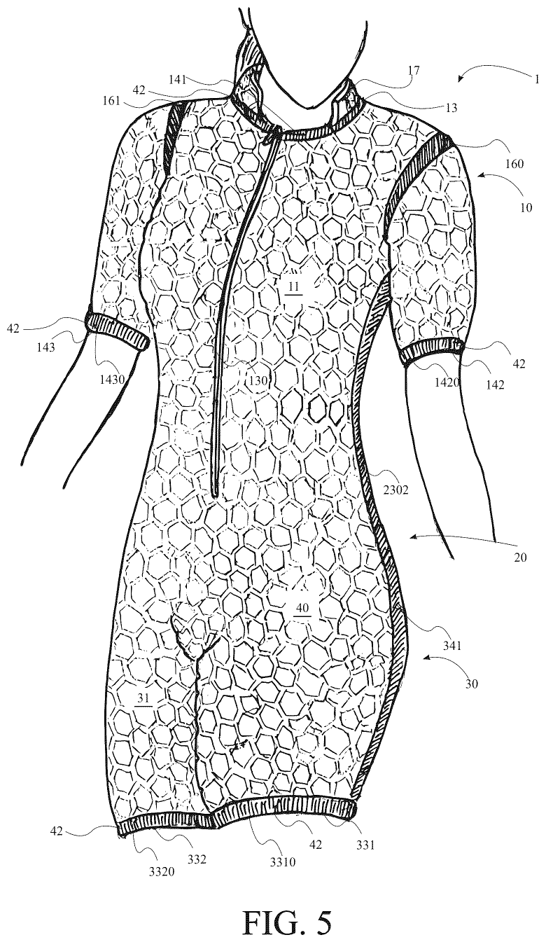

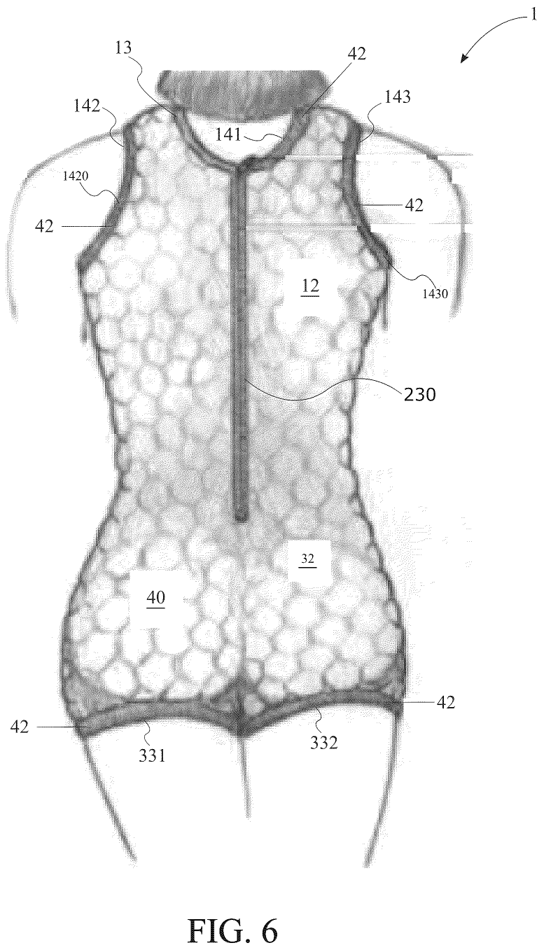

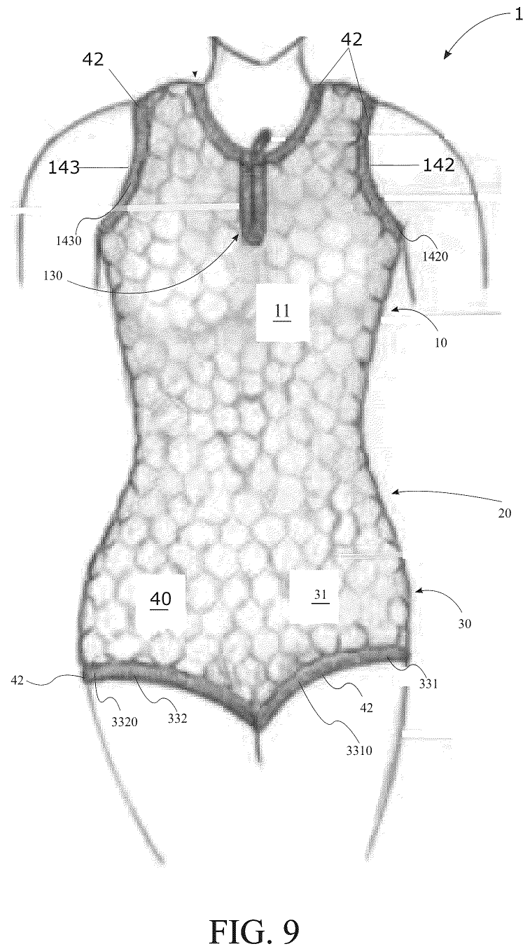

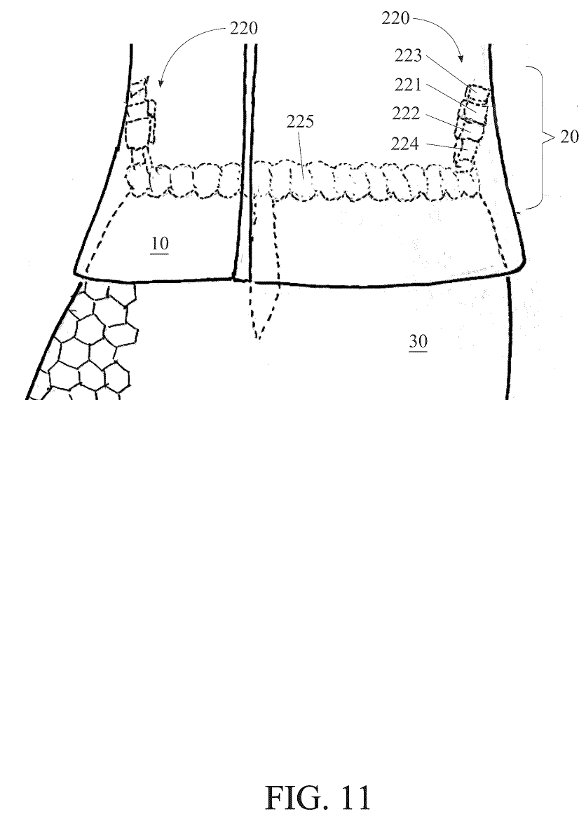

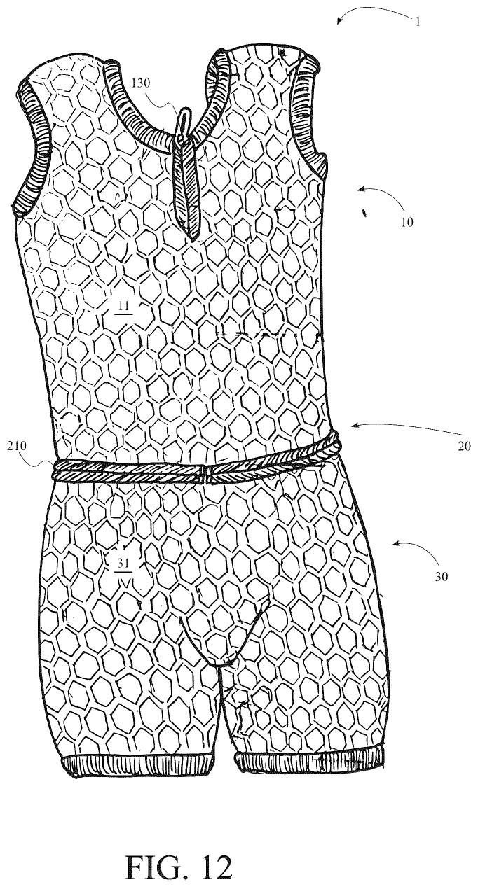

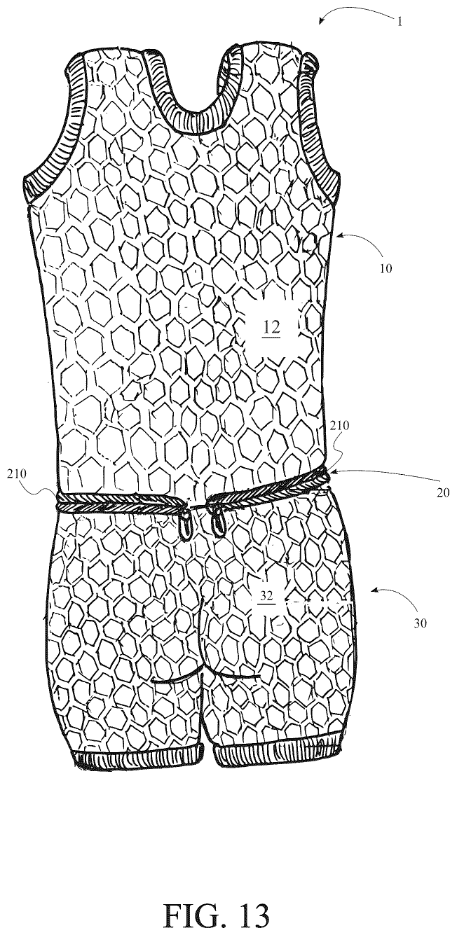

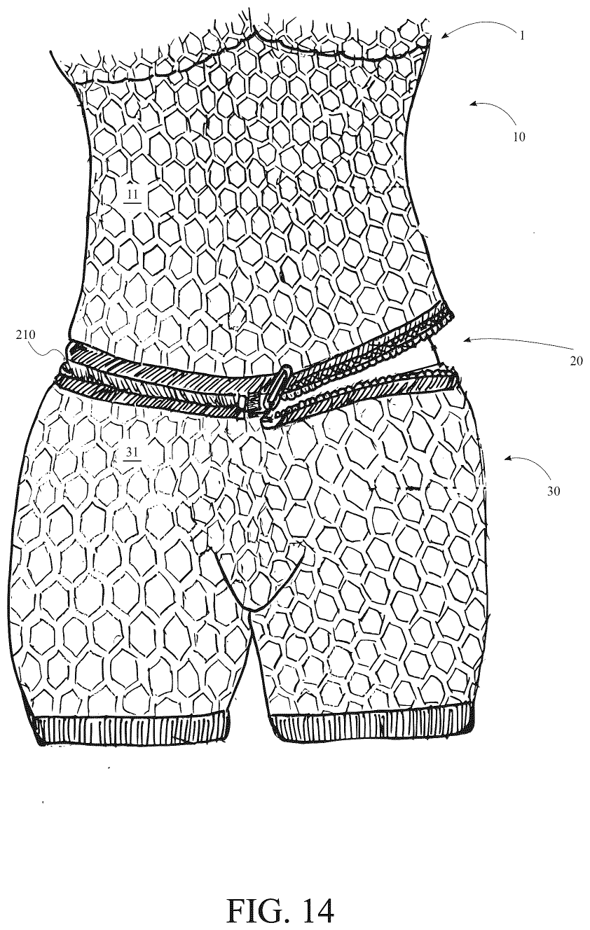

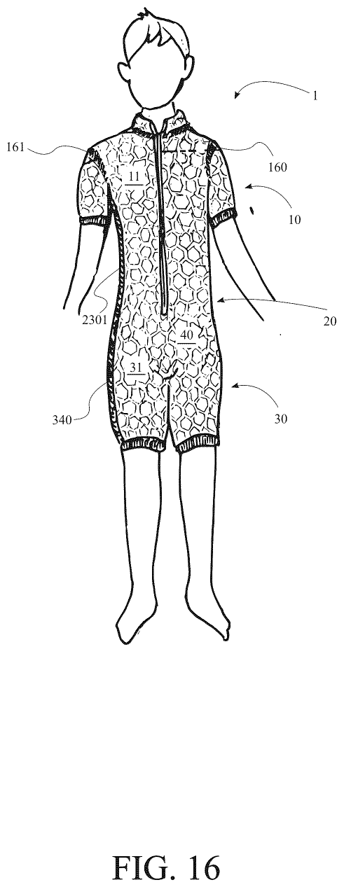

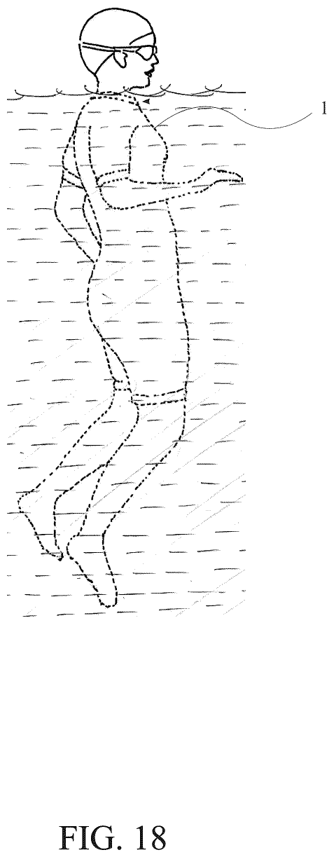

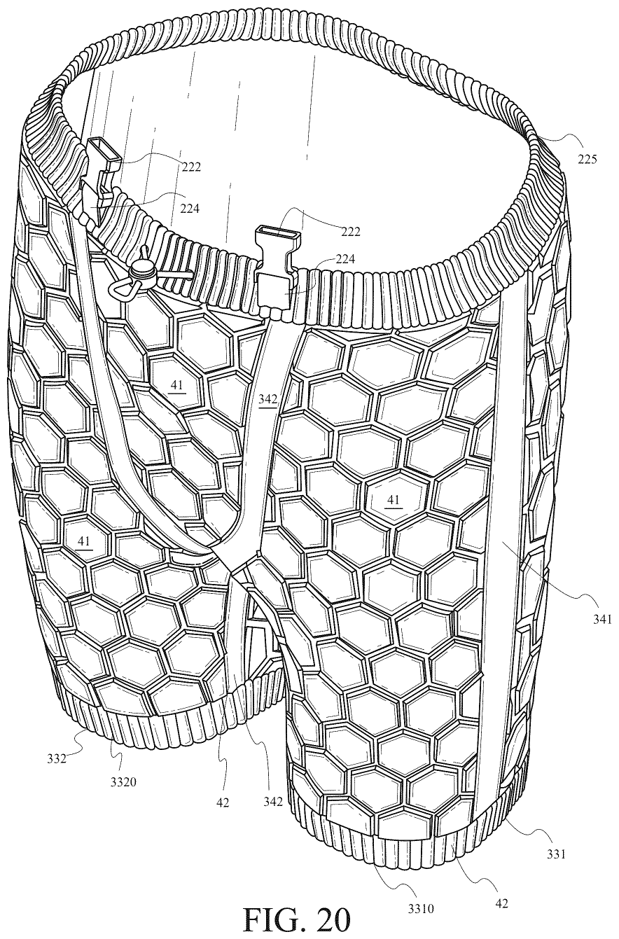

In the context of the present invention, up/top refers to the direction that is up in FIG. 1, FIG. 2, FIG. 3, FIG. 4, FIG. 20, FIG. 5, FIG. 6, FIG. 9, FIG. 11, FIG. 12, FIG. 13, FIG. 14, FIG. 16, and FIG. 18 and down/bottom is the direction opposite up.

As shown in FIG. 1-21, the present invention is a floating swimwear 1. The floating swimwear 1 comprises a buoyant material 40. The floating swimwear 1 is composed of said buoyant material 40. The floating swimwear 1 comprising the buoyant material 40, a front portion 11, covering a front facing portion of a user's body, and a rear portion 12, covering a rear facing portion of a user's body. In the context of the present invention, left, right, front, and back refer to the directions that are left, right, front, and back sides of the user, respectively. For example, left is the direction of where the left side of the user using the present invention would be when the user is using the present invention.

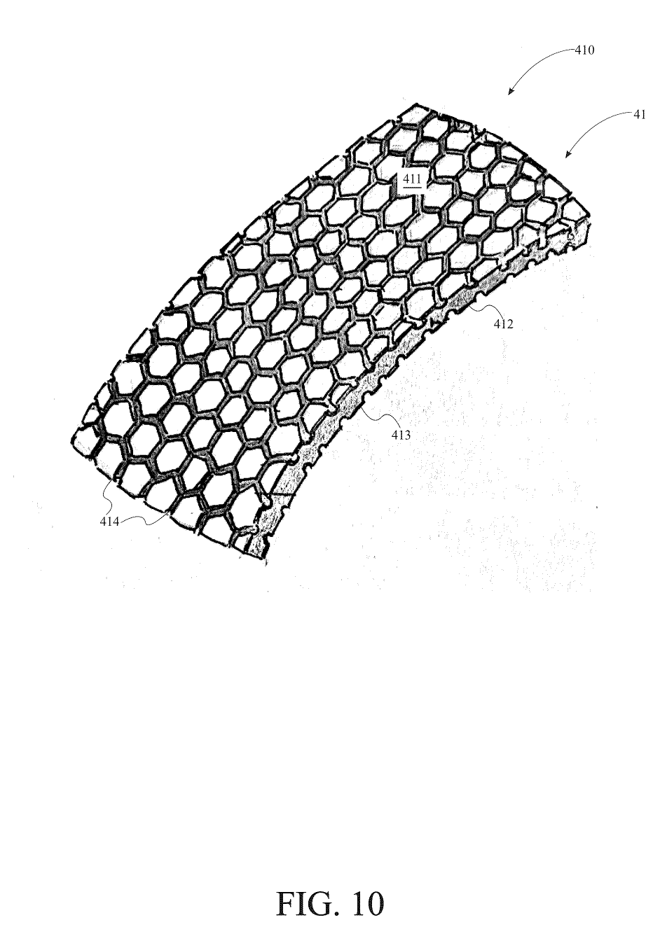

The buoyant material 40 comprises a low density material 41 and an elastic material 42. In the context of the present invention, the terms “low density” and “low-density” are understood to be interchangeable. The elastic material 42 is a material that has elastic qualities, including but not limited to spandex. The low density material 41 comprises a plurality of hexagonal low-density polyethylene sheets 410. As shown in FIG. 10, the hexagonal low density polyethylene sheets 410 comprise an outer spandex layer 411, a middle low density polyethylene layer 412, an inner spandex layer 413, and a stretchable spacing 414. The outer spandex layer 411 is the outermost most material of the hexagonal low density polyethylene sheets 410. The outer spandex layer 411 is an elastic synthetic fiber, wherein sheets of said fiber compose the outermost layer of the low density material 41. The middle layer, the middle low density polyethylene layer 412, is adjacent to the outer spandex layer 411, wherein said outer spandex layer 411 is atop said middle low density polyethylene layer 412. The middle low-low density polyethylene layer 412, in the preferred embodiment of the preset invention, are eight millimeter thick sheets of closed cell low density polyethylene. Adjacent to the middle low-density polyethylene layer 412 is the inner spandex layer 413. The inner spandex layer 413, when composed in the low density material 41, is the innermost layer, wherein the layer would be considered to be the “inside” of the floating swimwear 1, as known to one of ordinary skill. The inner spandex layer 413 is an elastic synthetic fiber, wherein sheets of said fiber compose the innermost layer of the low density material 41. The three layers, from outermost layer to innermost layer, are the outer spandex layer 411, the middle low-density polyethylene layer 412, and the inner spandex layer 413. The hexagonal low-density polyethylene sheets 41 are made wherein the three layers, in the aforementioned configuration, are placed into a hexagonal mold and are then fused together using pressure and heat, thus binding the layers together. The area between each hexagonal section is the stretchable spacing 414.

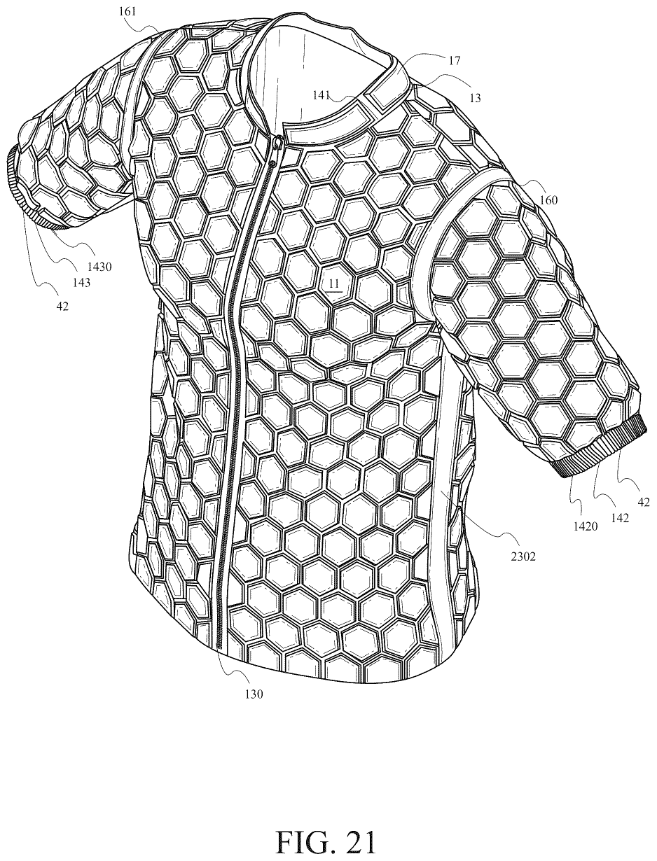

In some embodiments of the present invention, the floating swimwear further comprises a neckband 13, a left armband 1420, a right armband 1430, a left legband 3310, a right legband 3320, plurality of upper openings, and a plurality of bottom facing openings. The plurality of upper openings comprises a neck opening 141, a left upper opening 142, and a right upper opening 143. The plurality of bottom facing openings comprises a left bottom facing opening 331 and a right bottom facing opening 332. In some embodiments of the present embodiment of the present invention, as shown in FIG. 1, FIG. 3, FIG. 5, FIG. 6, FIG. 9, and FIG. 21, said neck opening 141 receives a neck of the user, the left upper opening 142 receives a left arm of a user, and the right upper opening 143 receives a right arm of a user. Likewise, the left bottom facing opening 331 receives a left leg of the user, whereas the right bottom facing opening 332 receives a right leg of the user.

The neckband 13, left armband 1420, right armband 1430, left legband 3310, and right legband 3320 are each composed of the elastic material. The left armband 1420 is positioned circumferentially around the left upper opening 142 covering a portion of the left arm of the user. The right armband 1430 is positioned circumferentially around the right upper opening 143, covering a portion of the right arm of the user. The left legband 3310 is positioned circumferentially around the left bottom facing opening 331, covering a portion of the left leg of the user. The right legband 3320 is positioned circumferentially around the right bottom facing opening 332, covering a portion of the right leg of the user.

As shown in FIG. 1, FIG. 2, FIG. 3, FIG. 5, and FIG. 21, in some embodiments of the present invention, the floating swimwear 1 further comprises a collar 17. The collar is composed of the low density material. The collar is positioned circumferentially around the neckband.

In some embodiments of the present invention, the floating swimwear 1 may further comprise at least one zipper assembly extending downwardly from the neckband 13, as shown in one embodiment as shown in FIG. 1 and FIG. 2. In said embodiment, the floating swimwear 1 comprises a first zipper assembly 130 and a rear zipper assembly 230, as shown in FIG. 1, FIG, 2, FIG. 5, FIG. 6, FIG. 9, and FIG. 12.

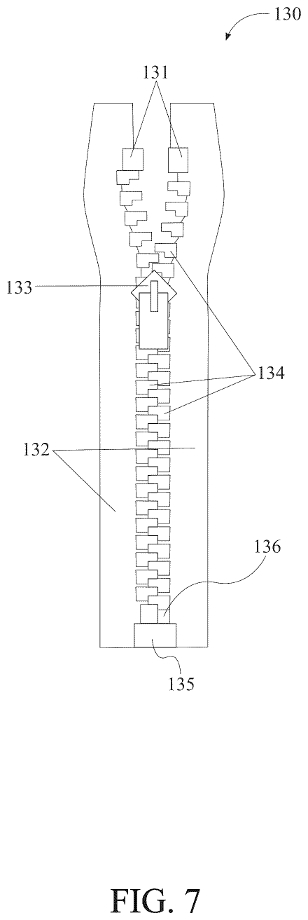

As shown in FIG. 7, The first zipper assembly 130 comprises a first top stop 131, a first tape 132, a first pull tab 133, a first set of teeth 134, a first box 135, and a first pin 136. In some embodiments wherein the floating swimwear 1 comprises the first zipper assembly 130, the first tape 132 is a material that is attached to the floating swimwear 1. The first set of teeth 134 are attached to both sides of the first tape 132. The first pull tab 133, which includes a slider, as understood by one of ordinary skill, engages with the first set of teeth 134 to open and close the zipper assembly. At the uppermost end of the first set of teeth 134, on the end located nearest the neckband 13, the first top stop 131 is positioned, preventing the first pull tab 133 from disengaging with the first zipper assembly 130. At the end of the first set of teeth 134, opposite of the first top stop 131, the first box 135 and first pin 136 are positioned. The first pin 136 removably engages with the first box 135, properly aligning the first set of teeth 134.

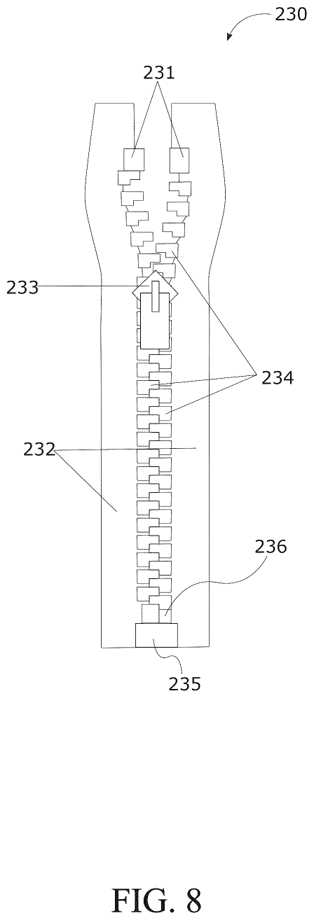

The rear zipper assembly 230, as shown in FIG. 8, comprises a rear top stop 231, a rear tape 232, a rear pull tab 233, a rear set of teeth 234, a rear box 235, and a rear pin 236. In some embodiments wherein the floating swimwear 1 comprises the rear zipper assembly 230, the rear tape 232 is a material that is attached to the floating swimwear 1. The rear set of teeth 234 are attached to both sides of the rear tape 232. The rear pull tab 233, which includes a slider, as understood by one of ordinary skill, engages with the rear set of teeth 234 to open and close the zipper assembly. At the uppermost end of the rear set of teeth 234, on the end located nearest the neckband 13, the rear top stop 231 is positioned, preventing the rear pull tab 233 from disengaging with the rear zipper assembly 230. At the end of the rear set of teeth 234, opposite of the rear top stop 231, the rear box 235 and rear pin 236 are positioned. The rear pin 236 removably engages with the rear box 235, properly aligning the rear set of teeth 234.

In some embodiments of the present invention, the floating swimwear 1 further comprises a plurality of flexible joints, as shown in FIG. 1, FIG. 2, FIG. 3, FIG. 4, FIG. 5, FIG. 20, FIG. 21, and FIG. 16. Each joint of the plurality of flexible joints is composed of the elastic material. Each joint of the plurality of flexible joints are attached to the low density material 41. The plurality of shoulder joints comprise a first plurality of flexible joints, a second plurality of flexible joints, and a third plurality of flexible joints. The first plurality of flexible joints comprises a left shoulder joint 160 and a right shoulder joint 161. The second plurality of flexible joints comprise a middle right side joint 2301 and a middle left side joint 2302. The third plurality of flexible joints comprises a bottom right side joint 340, a bottom left side joint 341, and a bottom center joint 342. The left shoulder joint 160 is positioned on a portion of the floating swimwear 1 that covers and surrounds the left shoulder of the user. In some embodiments of the present invention, the left shoulder joint 160 also extends along the portion of the floating swimwear 1 that covers a portion of the underside of the left upper arm of the user. The right shoulder joint 161 is positioned on a portion of the floating swimwear that covers and surrounds the right shoulder of the user. In some embodiments of the present invention, the right shoulder joint 161 also extends along the portion of the floating swimwear 1 that covers a portion of the underside of the right upper arm of the user, as seen in FIG. 3. The middle right side joint 2301 is positioned on a portion of the floating swimwear 1 covering the right side of the torso of the user, below the right shoulder of the user. The middle left side joint 2302 is positioned on a portion of the floating swimwear 1 covering the left side of the torso of the user, below the left shoulder. The bottom right side joint 340 is positioned on a portion of the floating swimwear 1 covering a portion of a right leg of the user, along the rightmost edge of the right thigh of the user. The bottom left side joint 341 is positioned on a portion of the floating swimwear 1 covering a portion of a left leg of the user, along the leftmost edge of the left thigh of the user. The bottom center joint 342 is positioned between the left legband and the right legband, covering the inner thigh of the user and the portion of the user where the inner thigh meets the waist.

In some embodiments of the present invention, as shown in FIG. 1 and FIG. 2, the floating swimwear 1 further comprises a harness 15. The harness 15 comprises a plurality of straps 150. The harness 15 is positioned on a portion of the floating swimwear 1 covering the torso of the user, wherein the harness 15 is located within the floating swimwear 1 receiving a left shoulder and a right shoulder of a user and extending down to a waist of the user. The harness 15 is positioned inside the floating swimwear 1, attached to the floating swimwear 1, such that the harness 15 wraps around the shoulders of the user and connects to a portion of the floating swimwear 1 that covers the waist of the user.

In some embodiments of the present invention, as shown in FIG. 1, FIG. 11, FIG. 12, FIG. 13, and FIG. 14, the floating swimwear 1 comprises multiple articles including a top portion 10, a middle portion 20, and a bottom portion 30. In said embodiment, wherein the floating swimwear 1 comprises multiple sections, the top portion 10 of the swimwear comprises the front portion 11, the rear portion 12, the neckband 13, the collar 17, the plurality of upper openings, the first plurality of flexible joints, the second plurality of flexible joints 230, and the harness 15. The bottom portion 30 comprises a front 31, a back 32, and the plurality of bottom facing openings. The middle portion 20 is a section wherein the top portion 10 and the bottom portion 30 of the floating swimwear 1 connect.

In the embodiment of the present invention as shown in FIG. 4 and FIG. 20, the bottom portion 30 comprises an elastic waistband 225. Furthermore, in the aforementioned embodiment as shown in FIG. 1, the middle portion 20 comprises a buckle assembly 220. As shown in FIG. 11, The buckle assembly 220 of the aforementioned embodiment comprises an at least one male buckle component 221, an at least one female buckle component 222, an at least one male buckle strap 223, and an at least one female buckle strap 224. The middle buckle assembly 220 may comprise a plurality of male buckle components 221, a plurality of female buckle components 222, a plurality of male buckle straps 223, and a plurality of female buckle straps 224. In the preferred embodiment of the embodiment of the present invention as shown in FIG. 11, the quantity of each of the aforementioned components share a 1:1:1:1 ratio with each other. In the embodiment of the present invention as shown in FIG. 11, the male buckle component 221 is attached to one end of the male buckle strap 223, wherein said male buckle strap 223 comprises two ends; and the female buckle component 222 is attached to one end of the female buckle strap 224, wherein said female buckle strap 224 comprises two ends. The end of male buckle strap 223 opposite of the male buckle component 221 is attached to one of either the top portion 10 or the bottom portion 30. The end of female buckle strap 224 opposite of the female buckle component 222 is attached to one of either the top portion 10 or the bottom portion 30, wherein the female buckle strap 224 is not attached to the same article as the male buckle strap 223. The male buckle component 221 and the female buckle component 222, may then be interlockingly engaged, thus securing the top portion 10 to the bottom portion 30 at the location of the middle portion 20.

In some embodiments of the present invention, the harness 15 attaches to the buckle assembly 220, such that each strap of the plurality of straps 150 attaches to a buckle of the top portion 10, as shown in FIG. 1.

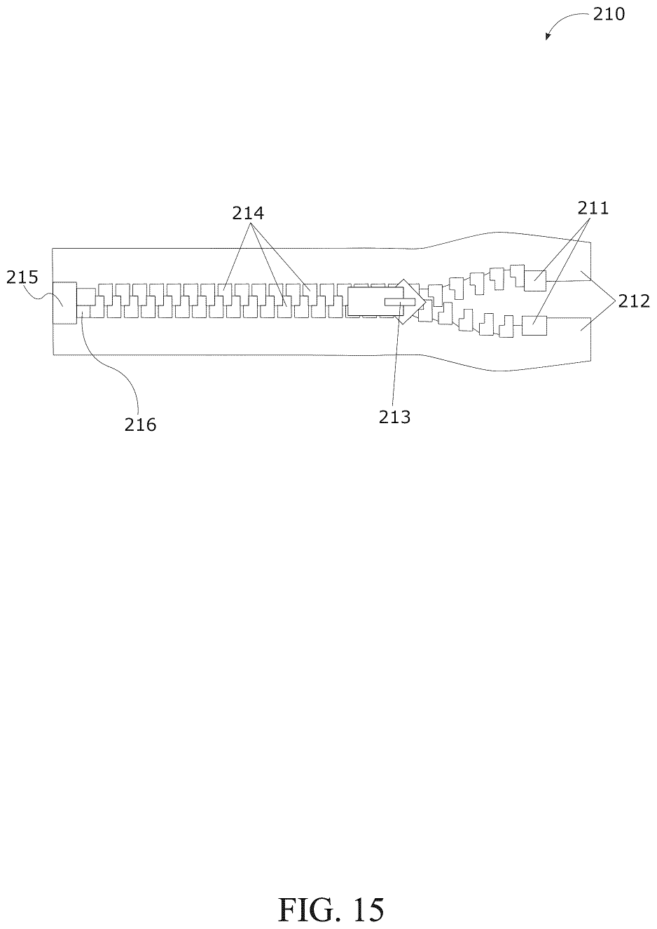

In some embodiments of the present invention, as shown in FIG. 12, FIG. 13, and FIG. 14, the middle portion 20 of the floating swimwear 1, comprises a middle zipper assembly 210, extending horizontally around the middle portion 20 of the floating swimwear 1, securing the top portion 10 to the bottom portion 30 of the floating swimwear 1. As shown in FIG. 15, the middle zipper assembly 210 comprises a middle stop 211, a middle tape 212, a middle pull tab 213, a middle set of teeth 214, a middle box 215, and a middle pin 216. In some embodiments wherein the floating swimwear 1 comprises the middle zipper assembly 210, the middle tape 212 is a material that is attached to the top portion 10 and the bottom portion 30 floating swimwear 1. The middle set of teeth 214 is attached to both sides of the middle tape 212. The middle pull tab 213, which includes a slider, as understood by one of ordinary skill, engages with the middle set of teeth 214 to open and close the zipper assembly. At the one end of the middle set of teeth 214, the middle stop 211 is positioned, preventing the middle pull tab 213 from disengaging with the middle zipper assembly 210. At the end of the middle set of teeth 214, opposite of the middle stop 211, the middle box 215 and middle pin 216 are positioned. The middle pin 216 removably engages with the middle box 215, properly aligning the middle set of teeth 214.

The present invention is not intended to be limited to any dimension and thus the present invention is able to be manufactured for adults and children as shown in FIG. 16. Because the buoyant material 40 is able to be manipulated, as any other material known to those in the art, said buoyant material 40 may be cut into various shapes and sizes as to fit any body type of the user.

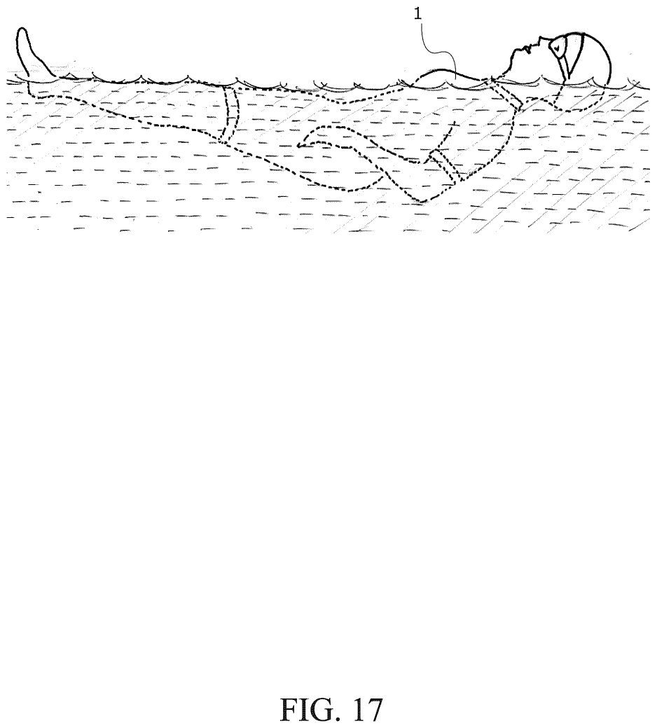

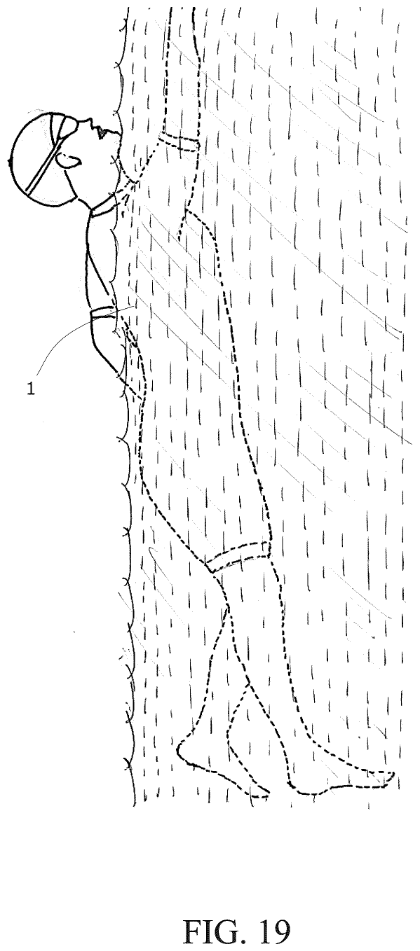

The intended use of the present invention is to provide the user with a set of swimwear that naturally aids in floating. Because the floating swimwear 1 is composed substantially of the buoyant material 40, when worn, the users will experience a buoyancy distribution that resembles natural buoyancy, as shown in FIG. 17. Furthermore, the construction of the floating swimwear 1, comprising the hexagonal low-density polyethylene sheets 41, which make up the buoyant material 40, users will not experience restrictions, limitations, or be impeded by the floating in their movements, as shown by the user swimming in FIG. 17, FIG. 18, and FIG. 19. The plurality of flexible joints are areas without the low density material 41, positioned to align with the joints of the user, so as to reduce the resistance the user may feel in moving. The collar 17 provides the user a more comfortable floating experience by providing a more secure fit and buoyancy closer to the head of the user, allowing the user to more easily keep their head above water. The harness provides stability in the floating swimwear 1, by keeping the floating swimwear 1 from lifting off of the user's body uncomfortably in the water (the harness secures the floating swimwear 1 more securely to the user's body).

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

Although the invention has been explained in relation to its preferred embodiment, it is to be understood that many other possible modifications and variations can be made without departing from the spirit and scope of the invention.

What is claimed is:

1. A floating swimwear comprising:
a front portion;
a rear portion;
a neckband;
a left legband;
a right legband;
a left armband;
a right armband;
a collar;
a harness comprising;
a plurality of straps;
a plurality of upper openings comprising;
a neck opening;
a left upper opening; and
a right upper opening;
a plurality of bottom openings comprising:
a left bottom facing opening; and
a right bottom facing opening;
a plurality of flexible joints comprising
a left shoulder joint;
a right shoulder joint;
a middle right side joint;
a middle left side joint;
a bottom right side joint;
a bottom left side joint; and
a bottom center joint; and
a buoyant material comprising;
a low density material; and
an elastic material;
the floating swimwear being fashioned from the buoyant material;
the plurality of flexible joints being fashioned from the elastic material;
the front portion covering a front facing portion of a body of a user;
the rear portion positioned adjacently opposed to the front facing portion, covering a backside of the user;
the plurality of upper openings positioned on a portion of the floating swimwear covering a torso of the user, wherein the neck opening is located near the top center of the floating swimwear receiving a neck of the user, the left upper opening facing leftwardly through the floating swimwear receiving a left arm of a user, and the right upper opening positioned opposed to the left upper opening, facing rightwardly through the floating swimwear receiving a right arm of the user;
the harness positioned on a portion of the floating swimwear covering the torso of the user, wherein the harness is located within the floating swimwear receiving a left shoulder and a right shoulder of a user and extending down to a waist of the user;
the neckband positioned circumferentially adjacent to the neck opening;
the neckband being fashioned from the elastic material;
the collar positioned circumferentially adjacent to the neckband, opposite the neck opening;
the collar being fashioned from the buoyant material;
the plurality of bottom openings facing downwardly wherein the left bottom facing opening receives a left leg of the user, and the right bottom facing opening receives a right leg of the user;
the left shoulder joint positioned on a portion of the floating swimwear that covers the left shoulder of the user;
the right shoulder joint positioned on a portion of the floating swimwear that covers the right shoulder of the user;
the middle right side joint positioned on a portion of the floating swimwear covering the right side of the torso of the user, below the right shoulder;
the middle left side joint positioned on a portion of the floating swimwear covering the left side of the torso of the user, below the left shoulder;
the bottom right side joint positioned on a portion of the floating swimwear covering a portion of a right leg of the user, along the rightmost edge of the right thigh of the user;
the bottom left side joint positioned on a portion of the floating swimwear covering a portion of a left leg of the user, along the leftmost edge of the left thigh of the user;
the left armband positioned circumferentially adjacent to the left upper opening;
the right armband positioned circumferentially adjacent to the right upper opening;
the left legband positioned circumferentially adjacent to the left bottom facing opening;
the right legband positioned circumferentially adjacent to the right bottom facing opening; and
the bottom center joint positioned between the left legband and the right legband.

2. The floating swimwear of claim 1, wherein the neckband and the front portion comprise an at least one zipper assembly comprising a first zipper assembly wherein said first zipper assembly comprises:
a first top stop;
a first tape;
a first pull tab;
a first set of teeth;
a first box; and
a first pin;
the at least one zipper assembly extending from the neckband downwardly unto the front portion;
the first tape attached between the first set of teeth and the front portion on both sides of the first set of teeth, positioned vertically on the front portion of the floating swimwear;
the first top stop is attached to the neckband and engaging with a top end of the first set of teeth;
the first box and the first pin attached to an opposing end of the first set of teeth from the first top stop, wherein the first pin engages with the first box; and
the first pull tab engaging the first set of teeth, wherein the first pull tab is able to move laterally along the first set of teeth.

3. The floating swimwear as claimed in claim 1, wherein the low density material comprises a plurality of hexagonal low-density polyethylene sheets.

4. The floating swimwear as claimed in claim 3 wherein the plurality of hexagonal low density polyethylene sheets comprise:
an outer spandex layer;
a middle low density polyethylene layer;
an inner spandex layer; and
a stretchable spacing;
the outer spandex layer attached atop the middle low-density polyethylene layer;
the middle low-density polyethylene layer attached atop the inner spandex layer; and
the stretchable spacing forming a perimeter area around the middle low density polyethylene layer wherein the stretchable spacing engages at least two of the middle low density polyethylene layer.

5. The floating swimwear of claim 1, wherein the neckband and the rear portion comprise a rear zipper assembly:
a rear top stop;
a rear tape;
a rear pull tab;
a rear set of teeth;
a rear box; and
a rear pin;
the rear zipper assembly extending from the neckband downwardly unto the rear portion;
the rear tape attached between the rear set of teeth and the rear portion on both sides of the first set of teeth, positioned vertically on the rear portion of the floating swimwear;
the rear top stop is attached to the neckband and engaging with a top end of the rear set of teeth;
the rear box and the rear pin attached to an opposing end of the rear set of teeth from the rear top stop, wherein the rear pin engages with the rear box; and
the rear pull tab engaging the rear set of teeth, wherein the rear pull tab is able to move laterally along the rear set of teeth.

6. A floating swimwear comprising:
a top portion comprising:
a front portion;
a rear portion;
a neckband;
a left armband;
a right armband;
a plurality of upper openings comprising:
a neck opening;
a left upper opening; and
a right upper opening; and
a first plurality of flexible joints comprising;
a left shoulder joint; and
a right shoulder joint;
a middle portion comprising;
a second plurality of flexible joints comprising;
a middle right side joint; and
a middle left side joint;
a harness comprising;
a plurality of straps;
a bottom portion comprising
an elastic waistband;
a third plurality of flexible joints comprising;
a bottom right side joint;
a bottom left side joint; and
a bottom center joint; and
a buoyant material comprising;
a low density material; and
an elastic material;
the floating swimwear being fashioned from the buoyant material;
the first plurality of flexible joints fashioned from the elastic material;
the second plurality of flexible joints fashioned from the elastic material;
the top portion being covering a torso of a user;
the top portion comprising a front portion wherein said front portion covers a portion of a front facing torso area of a user, a rear portion wherein said rear portion opposes the front portion, wherein said rear portion covers a portion of a back of a user;
the plurality of upper openings positioned on the top portion of the floating swimwear, wherein the neck opening is located near the top center of the floating swimwear receiving a neck of the user, the left upper opening facing leftwardly through the floating swimwear receiving a left arm of a user, and the right upper opening positioned opposed to the left upper opening, facing rightwardly through the floating swimwear receiving a right arm of the user;
the neckband positioned circumferentially adjacent to the neck opening;
the collar positioned circumferentially adjacent to the neckband, opposite the neck opening;
the bottom portion covering a portion of a left leg of a user and a portion of a right leg of a user;
the elastic waistband being attached to an upper portion of the bottom portion of the floating swimwear about a waist of a user;
the harness being attached to the top portion and the middle portion, extending from about the waist of the user to about a left shoulder and a right shoulder of a user.
the left shoulder joint positioned on a portion of the floating swimwear that covers the left shoulder of the user;
the right shoulder joint positioned on a portion of the floating swimwear that covers the right shoulder of the user;
the middle right side joint positioned on a portion of the floating swimwear covering the right side of the torso of the user, below the right shoulder;
the middle left side joint positioned on a portion of the floating swimwear covering the left side of the torso of the user, below the left shoulder;
the left armband positioned circumferentially adjacent to the left upper opening;
the right armband positioned circumferentially adjacent to the right upper opening;
the top portion removably attaching to, and at least partially overlapping, the lower portion at the location of the middle portion;

7. The floating swimwear in claim 6, wherein the bottom portion comprises:
a front side;
a rear side;
a plurality of bottom facing openings comprising;
a left bottom facing opening; and
a right bottom facing opening;
a third plurality of flexible joints comprising;
a bottom right side joint;
a bottom left side joint; and
a bottom center joint;
a left legband;
a right legband;
the front side covering a front facing portion of a portion of a lower body of a user;
the left bottom facing opening receiving a left leg of a user;
the right bottom facing opening receiving a right leg of a user;
the third plurality of flexible joints fashioned from the elastic material;
the rear side opposing the front side, covering the rear facing portion of the lower body of the user;
the plurality of bottom facing openings facing near a lower portion of the bottom portion of the floating swimwear, opening downwardly, receiving a left and a right leg of the user;
the bottom right side joint positioned on a portion of the floating swimwear covering a portion of a right leg of the user, along the rightmost edge of the right thigh of the user;
the bottom left side joint positioned on a portion of the floating swimwear covering a portion of a left leg of the user, along the leftmost edge of the left thigh of the user;
the left legband positioned circumferentially adjacent to the left bottom facing opening;
the right legband positioned circumferentially adjacent to the right bottom facing opening; and
the bottom center joint positioned between the left legband and the right legband.

8. A floating swimwear as claimed in claim 7, wherein the middle portion comprises:
a middle zipper assembly comprising:
a middle stop;
a middle tape;
a middle pull tab;
a middle set of teeth;
a middle box; and
a middle pin;
the middle zipper assembly extending horizontally about the waist of a user, connecting the top portion to the bottom portion;
the middle tape attached to the middle set of teeth;
the middle tape further attached to the top portion and the bottom portion of the floating swimwear;
the middle stop is attached to one end of the middle set of teeth;
the middle box and the middle pin attached to an opposing end of the middle set of teeth from the middle top stop, wherein the middle pin engages with the middle box; and
the middle pull tab engaging the middle set of teeth, wherein the middle pull tab is able to move laterally along the middle set of teeth.

9. A floating swimwear as claimed in claim 7, wherein the middle portion comprises a middle buckle assembly;

10. The floating swimwear as claimed in claim 9, wherein the middle buckle assembly comprises:
an at least one male buckle component;
an at least one female buckle component;
an at least one male buckle strap;
an at least one female buckle strap; and
an elastic waistband;
the at least one male buckle strap attaching to one of the articles consisting of either the top portion or the bottom portion;
the at least one female buckle strap attaching to one of the articles consisting of either the bottom portion or the top portion, wherein said article in which the at least one female buckle strap is attached to is not the same article in which the at least one male buckle strap is attached to;
the at least one male buckle component attached to the at least one male buckle strap;
the at least one female buckle component attached to the at least one female buckle strap;
the at least one male buckle component interlockingly engaging with the at least one female buckle component; and
the middle buckle assembly being located proximate to the elastic waistband.

11. The floating swimwear as claimed in claim 10, wherein the middle buckle assembly couples to the harness.

12. The floating swimwear as claimed in claim 11, wherein the at least one male
buckle strap is attached to the top portion, and the plurality of straps compose the at least one male buckle strap

13. A floating swimwear comprising;
a buoyant material comprising;
A low density material; and
An elastic material;
a plurality of flexible joints; and
a harness;
wherein:
the floating swimwear is composed of the buoyant material;
the plurality of flexible joints is composed of the elastic material;
the harness is inside of the floating swimwear.

14. The floating swimwear of claim 13, wherein said low density material comprises a plurality of hexagonal low density polyethylene sheets.

15. The floating swimwear as in claim 14 wherein the hexagonal low density polyethylene sheets comprise an outer spandex layer.

16. The floating swimwear as in claim 14 wherein the hexagonal low density polyethylene sheets comprise a middle layer comprising a low-density polyethylene.

17. The floating swimwear as in claim 15 wherein the hexagonal low density polyethylene sheets comprise the outer spandex layer and an inner spandex layer.

18. The floating swimwear as in claim 14 wherein the hexagonal low density polyethylene sheets comprise a stretchable spacing.

19. The floating swimwear as in claim 15 wherein the hexagonal low density polyethylene sheets comprise an outer spandex layer, an inner spandex layer, a middle layer comprising low density polyethylene, and a stretchable spacing.

20. The floating swimwear as claimed in claim 19 further comprising:
a plurality of upper openings comprising:
a neck opening;
a left upper opening; and
a right upper opening;
a plurality of bottom openings comprising:
a left bottom facing opening; and
a right bottom facing opening;
a left legband;
a right legband;
a left armband;
a right armband;
a neckband; and
a soft elastic lining;
the neckband being composed of the soft elastic lining;
the left legband being composed of the soft elastic lining;
the right legband being composed of the soft elastic lining;
the left armband being composed of the soft elastic lining;
the right armband being composed of the soft elastic lining.
